(19) United States
(12) Patent Application Publication
(10) Pub. No.: US 2012/0255807 A1
(43) Pub. Date: Oct. 11, 2012

(54) FIREARM SUPPRESSOR DEVICE AND METHODS OF USE

(76) Inventor: Daniel Pieratti, Fernandina Beach, FL (US)

(21) Appl. No.: 13/440,194

(22) Filed: Apr. 5, 2012

Related U.S. Application Data
(60) Provisional application No. 61/473,383, filed on Apr. 8, 2011.

(51) Int. Cl. F41A 21/30; B23P 6/00

(52) U.S. Cl. 181/223; 29/896.2

(57) ABSTRACT

A firearm suppressor device with improvements over the prior art is disclosed. In some embodiments, the firearm suppression comprises a sleeve, first and second end caps, a sacrificial block, and a suppression insert. The first and second end caps may removably attachable to the sleeve, for example, by compatible threading on the end caps and the sleeve. The first or second end caps may also comprise means to facilitate removal of the end cap from the sleeve, for example, a knurled finish to increase friction with a user's hand. Some embodiments of the firearm suppressor device may be used for different types and caliber of firearms, such as pistols and rifles.

### CROSS REFERENCE TO RELATED APPLICATIONS

This application claims priority under 35 U.S.C. Section 119(e) to U.S. Provisional Application 61/473,383, entitled Firearm Suppressor Device and Methods of Use, filed on Apr. 8, 2011.

### BACKGROUND OF THE INVENTION

1. Field of the Invention

The invention relates to suppressor devices, particularly for firearms.

2. Description of the Related Art

It is well known in the field of firearms to modify barrels to compensate for various effects of firing a bullet or other projectile. Some of the effects are muzzle jump and/or recoil and muzzle blast. Each of these effects can be undesirable for reasons of accuracy, secrecy, and general safety to the operator. Muzzle jump or recoil can adversely impact accuracy and reduce the rate of delivery of projectiles on target accurately. Muzzle blast is the loud noise and flash generally accompanying the discharge of a firearm. The noise can damage the ears of the operator or nearby individuals not wearing ear protectors and can bring unwanted attention in instances of covert use. The flash also can adversely affect night vision and draw unwanted attention to the use of the firearm.

### BRIEF DESCRIPTION OF THE DRAWINGS

FIG. 1 depicts one embodiment, a firearm suppressor device having a sleeve, a threaded end cap, an exiting end cap, a sacrificial block, and a suppression insert. A section view through the device is provided.

FIG. 2 provides details of the threaded end cap according to the embodiment depicted in FIG. 1.

FIG. 3 provides details of the exiting end cap according to the embodiment depicted in FIG. 1.

FIG. 4 provides details of the sleeve according to the embodiment depicted in FIG. 1.

FIG. 5 provides details of the sacrificial block according to the embodiment depicted in FIG. 1.

FIG. 6 provides details of the suppression insert according to the embodiment depicted in FIG. 1.

FIGS. 7-9 are perspective views of alternate embodiments of the firearm suppressor depicted in FIG. 1, illustrating different materials and sizes.

### DETAILED DESCRIPTION OF THE PREFERRED EMBODIMENT

Embodiments disclosed herein are directed to firearm suppressor devices and methods of use of the same.

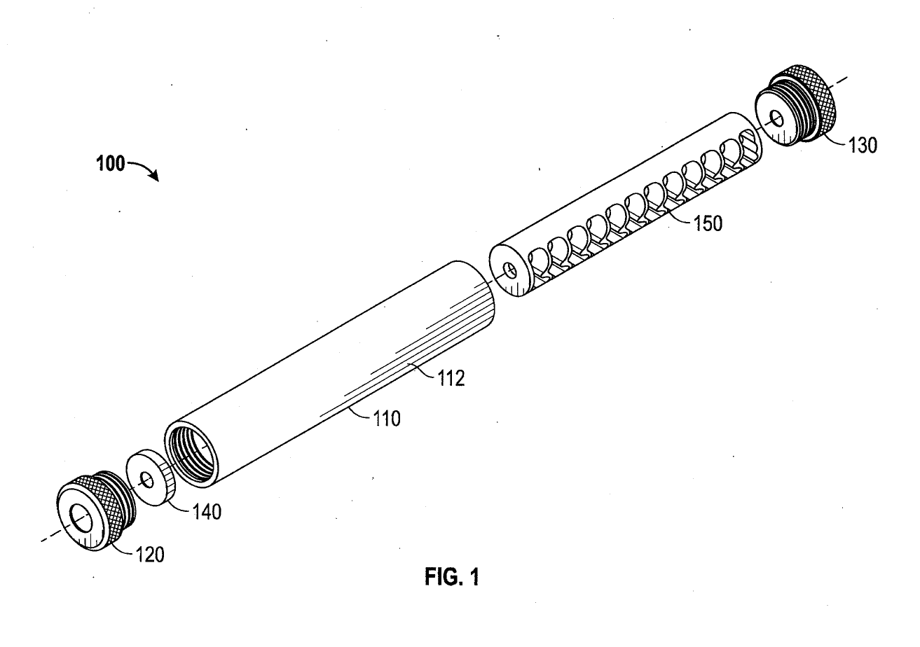

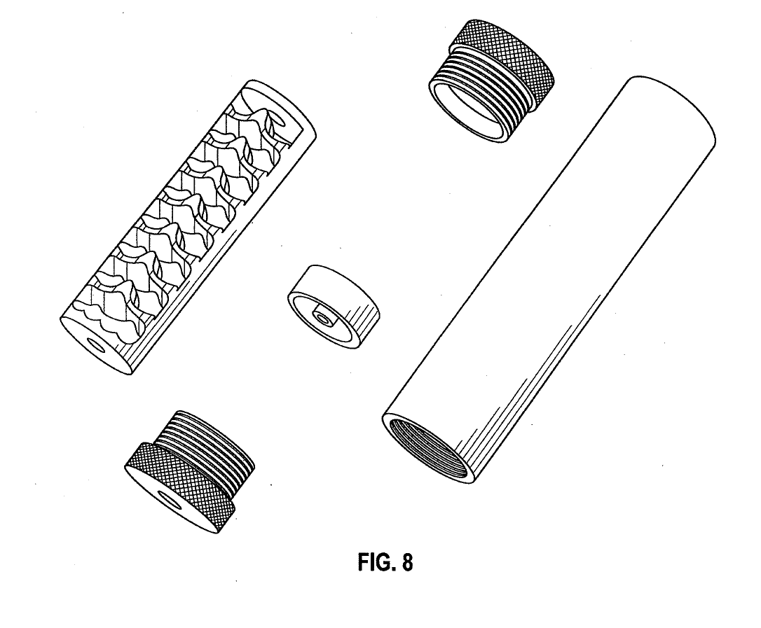

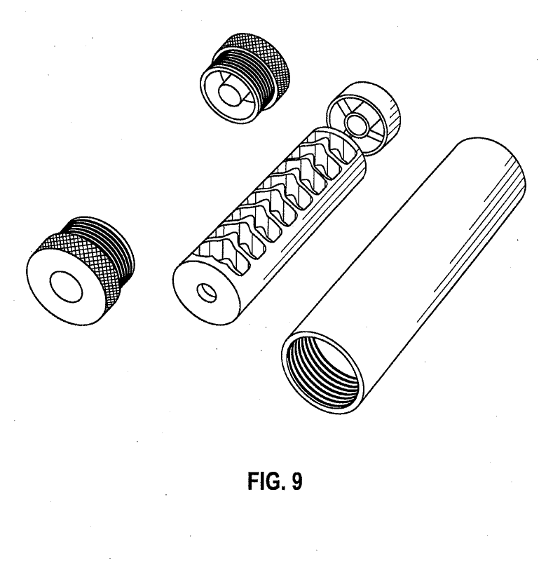

FIGS. 1-9 depicts a firearm suppressor device 100 having a sleeve 110, a threaded end cap 120, an exiting end cap 130, a sacrificial block 140, and a suppression insert 150. The components of the device 100 are shown assembled in FIG. 1A. When assembled, the sacrificial block 140 and suppression insert 150 are disposed within the sleeve 112 and longitudinally between the threaded end cap 120 and the exiting end cap 130, which are attached to the sleeve 110. The longitudinal axis is generally defined as the line passing through the center of the device 100, parallel to the outer wall 112 of the sleeve 100 when the device 100 is assembled. The longitudinal direction is any direction parallel to the longitudinal axis. The transverse direction is perpendicular to the longitudinal direction. When assembled, the suppressor device 100 defines an aperture 200 along the longitudinal axis through which a projectile (not shown) may travel. The assembled suppressor device 100 may be attached to the barrel of a firearm (not shown) at the threaded end cap 120.

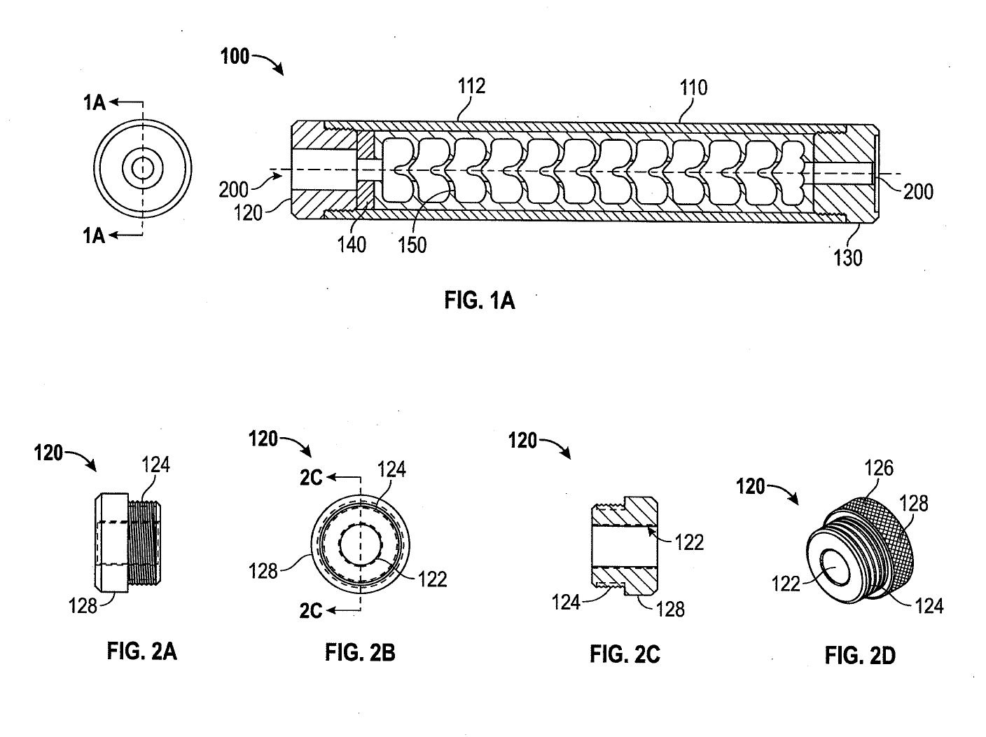

FIG. 2 illustrates features of the threaded end cap 120. The threaded end cap 120 is the portion of the firearm suppressor device 100 through which a projectile, e.g. a bullet, enters from the firearm (not shown). The threaded end cap 120 has inner threads 122 for attachment of the threaded barrel of a firearm. Outer threads 124 are also provided. The outer threads allow for attachment to the sleeve 110. The threaded end cap has a knurled surface 126 on a portion 128 of its exterior. The knurled surface 126 increases friction between the threaded end cap 120 and, for example, a user's hand, facilitating loosening and tightening the cap.

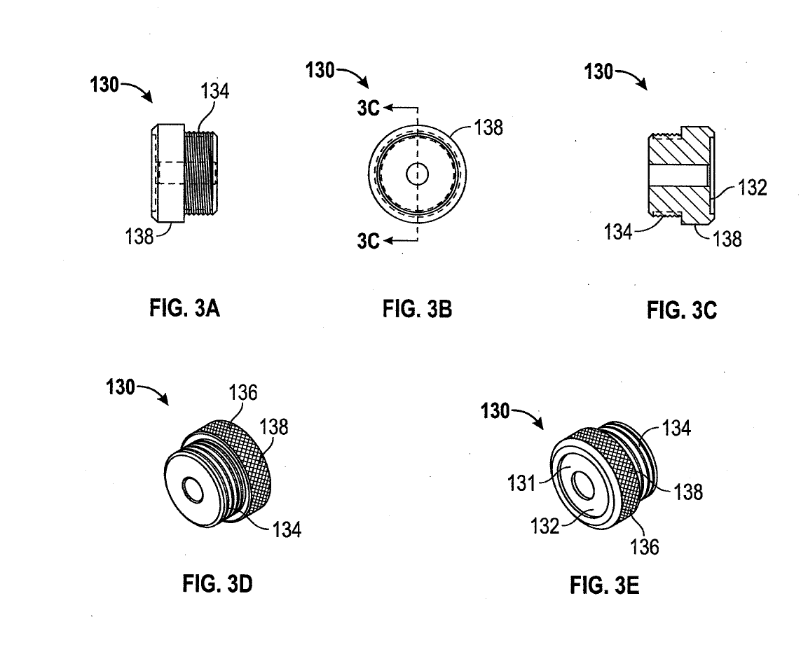

FIG. 3 illustrates features of the exiting end cap 130. The exiting end cap 130 is the portion of the firearm suppressor device 100 through which a projectile exits. The exiting end cap 130 may comprise an undercut area 132 on its face 131. The exiting end cap also has outer threads 134 for attachment to the sleeve 110. The exiting end cap has a knurled surface 136 on a portion 138 of its exterior. The knurled surface 136 increases friction between the exiting end cap 130 and, for example, a user's hand, facilitating loosening and tightening the cap.

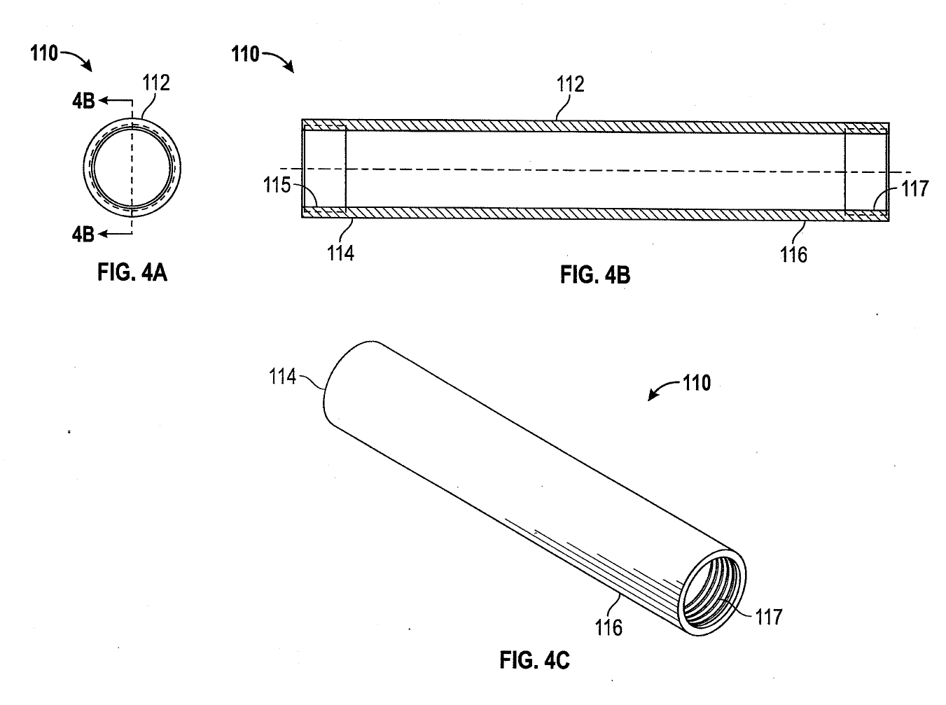

FIG. 4 illustrates features of the sleeve 110. The sleeve as shown comprises a solid, cylindrical member, with an outer wall 112, distal end 114, and proximal end 116. Threading 115, 116 is shown on the inside of the outer wall 110 for the attachment of the threaded end cap 120 and exiting end cap 130.

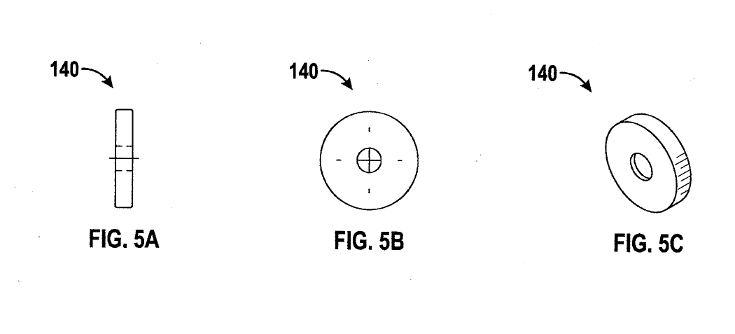

FIG. 5 illustrates the features of the sacrificial block 140. The sacrificial block 140 is shown as generally cylindrical in shape, having an inner diameter and outer diameter. When the firearm suppression device 100 is assembled, the sacrificial block 140 is disposed radially within the sleeve 110 and longitudinally between the threaded end cap 120 and the suppression insert 150. The sacrificial block is used to protect the suppression insert from the heat and pressure of the gasses and any unburned gunpowder discharged from the expulsion of a projectile from the end of a firearm barrel into the suppressor device 100.

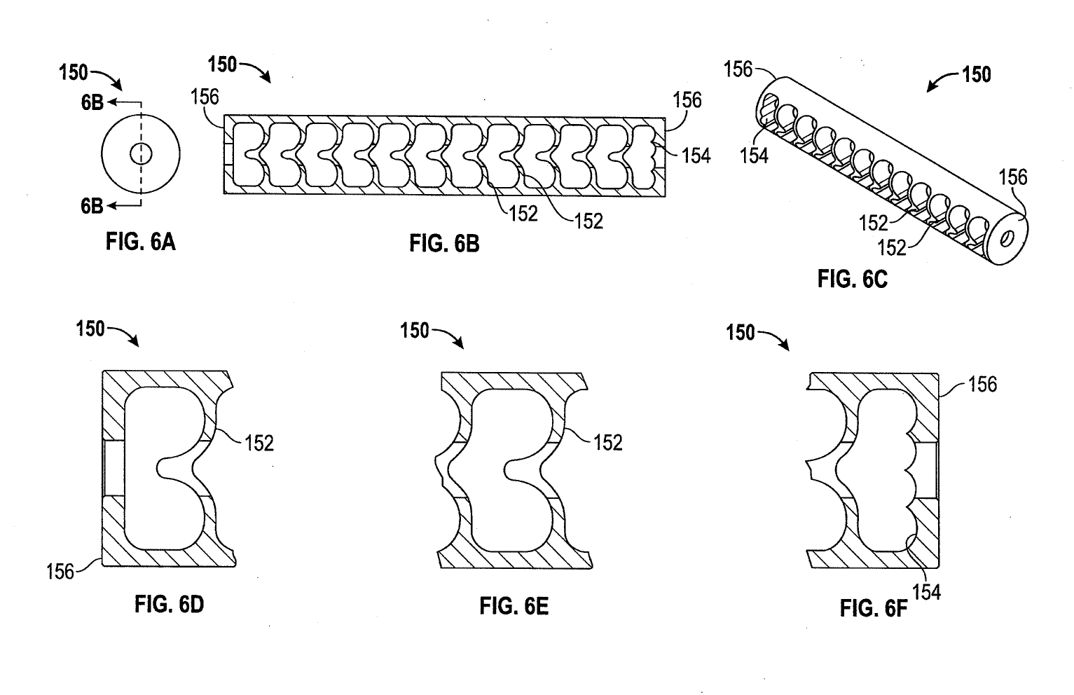

FIG. 6 illustrates the suppression insert 150. When the firearm suppression device 100 is assembled, the suppression insert is disposed radially within the sleeve 110 and longitudinally between the exiting end cap 130 and the sacrificial block 140. The suppression insert is used to trap the gasses that escape from the end of the firearm barrel (not shown) during the expulsion of the projectile from the barrel. The suppression insert 150 traps and slows the gasses, thereby reducing the gasses' auditory effect. To accomplish this quieting effect, the suppression insert may comprise a plurality of baffles 152 that are disposed longitudinally from each other along the length of the suppression insert 150. The insert 150 is also shown with fluting 154 on the surface of the end 156 of insert 150, facing the baffles 152. Both the baffles 152 and the fluting 154 are shown to be prismatic in the transverse direction. However, other configurations and combinations of and number of baffles and fluting may be provided. For example, instead of being prismatic in the transverse direction, the fluting or baffles may define patterns that extend radially about the longitudinal axis.

Some aspects of the firearm suppression device 100 may assist easy cleaning of the device. The threaded end cap 120 and/or exiting end cap 130 may be removed to provide access to the suppression insert 150, sacrificial block 140, and the inside of the sleeve 110 for cleaning. Once one or both end caps 120, 130 have been removed, the suppression insert 150 and sacrificial block 140 may be removed and cleaned, allowing access for cleaning the inside of the sleeve 110. This also allows for easy inspection and replacement of the sacrificial block 140. Likewise, the shape of the fluting 154 and baffles 152 may facilitate cleaning the suppression insert 140. For example, a brush used to clean the transversely prismatic baffles may travel transversely through the suppression insert, maintaining contact with the baffle throughout the process. As a result, the brush will be able to contact a large portion of the surface area of the baffles, increasing the efficiency and ease of cleaning the device. If the baffles were not prismatic in the transverse direction, dirt or dust may become trapped and unreachable by a brush. The same reasoning applies to transversely prismatic fluting. Other aspects of the baffles and fluting may also assist with cleaning, including, but not limited to, the presence of generally rounded corners.

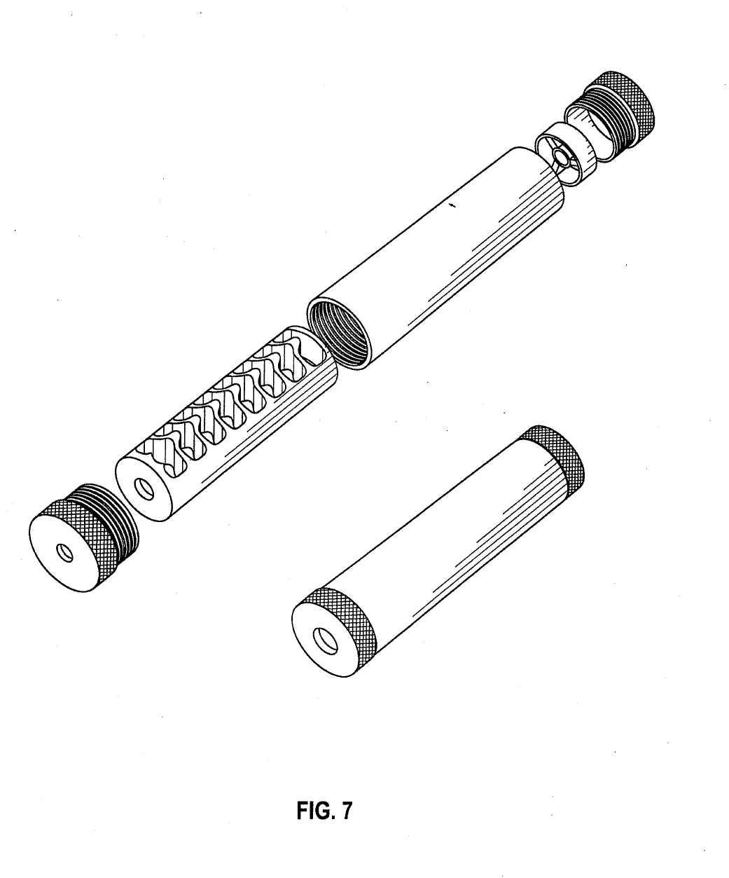

FIGS. 7-9 depict a variety of configurations and sizes of firearm suppression devices according to other embodiments. In some embodiments, the materials used for each component of the suppression device may vary. In other embodiments, some components may be constructed from one material, while another component is constructed from another material. In some embodiments, common metals, exotic metals, or both are used.

What is claimed is:

1. A firearm suppressor comprising:
a sleeve;
a baffled suppressor insert positioned inside the sleeve;
a sacrificial block positioned inside the sleeve;
at least one end cap removably coupled to the sleeve;
wherein the at least the sacrificial block can be removed from the sleeve when the end cap is removed.

2. The suppressor of claim 1, wherein the baffled suppressor insert can be removed when the end cap is removed.

3. A method of maintaining a firearm suppressor comprising removing and replacing a sacrificial block contained within the suppressor.
